(19) United States
(12) Patent Application Publication
(10) Pub. No.: US 2007/0294939 A1
(43) Pub. Date: Dec. 27, 2007

(54) Enhanced fungal substrate and carrier

(76) Inventors: Mark C. Spear, Kittanning, PA (US); Bruce Atwood, Tallahassee, FL (US)

Correspondence Address: RENNER KENNER GREIVE BOBAK TAYLOR & WEBER, FIRST NATIONAL TOWER FOURTH FLOOR, 106 S. MAIN STREET, AKRON, OH, 44308, US

(21) Appl. No.: 11/472,595

(22) Filed: Jun. 22, 2006

(51) Int. Cl. A01G 1/04

(52) U.S. Cl. 47/1.1

(57) ABSTRACT

A composition and method for the formulation of ingredients for a medium for growing fungi and the like. The invention provides for a formulation of a growing medium including oat hulls for the cultivating of mushroom mycelium.

### BACKGROUND OF THE INVENTION

1. Field of the Invention

The present invention relates to compositions and methods for growing fungi and the like, in general, and a formulation of ingredients for a medium and a method for growing fungi and the like, in particular.

2. Description of the Background

Mushroom is a generic term that describes numerous species of fungus and the edible varieties of mushrooms have general popularity as a food source. To cultivate mushrooms, mushroom farmers plant spawn instead of seeds or spores. Spawn is a pure culture of the mushroom fungus grown and delivered on a nutrient carrier. The production of spawn is typically carried out in a commercial lab environment. Sinden (U.S. Pat. No. 2,044,861, the disclosure of which is incorporated herein by reference) developed a grain-based spawn. Grain spawn remains the most popular mushroom spawn formulation in the mushroom farming industry. Spawn is often formulated by combining several ingredients including mushroom cells, a grain kernel such as wheat, rye or millet, a buffering agent such as calcium carbonate or calcium sulfate, and water. Spawn supports the multiplication of mushroom cells in a form usable by mushroom cultivators.

Since 1935, alternative spawn formulations have been developed including both grain and non-grain based substrates, examples of these are: flocculating agents (Stoller, U.S. Pat. No. 3,828,470), microcapsules (Holtz, U.S. Pat. No. 4,420,319), cotton (Tan, EPA 0107911), pre-swollen grains (Tan, U.S. Pat. No. 4,542,608), hydrogel (Romaine, U.S. Pat. No. 4,803,800), sulfate pulp waste (Masakuni, Japanese Pat. No. JP 6-090619), fermentation liquids (Holtz, U.S. Pat. No. 5,934,012), perlite (Bascougnet, WO 96/05720), protein (Kananen, U.S. Pat. No. 6,041,544), and paper (Kananen WO 99/041969), the disclosures of these patents are incorporated herein by reference. These formulations are referred to as substrate spawns.

Typically, mushroom cultivation involves several well defined steps. First, a specific nutritive matrix or medium is produced (mushroom compost, sawdust, etc.). This material is usually pasteurized or sterilized. Then, substrate spawn is added and mixed through in a step referred to as spawning.

After spawning the mushroom mycelium grows out from the spawn and colonizes the nutritive matrix. In many common instances this may take from 13 to 16 days. This step is referred to as spawn run.

After the spawn run, some species of mushroom require the addition of a non-nutritive layer on top of the nutritive matrix in order to stimulate the fungus to produce mushrooms. This non-nutritive layer is referred to as the casing layer. Typically, the casing layer is composed of a mix of peat moss and buffering agents or soil. Also, a number of non-grain substrates have been developed to bring the mushroom fungus into the casing layer on top of the mushroom beds. These formulations are referred to as casing spawns. The casing spawn typically comprises mixtures of perlite, vermiculite, colonized compost or the like. The addition of casing spawns has been found to reduce the duration it takes for mycelium to colonize the casing. The period where the mushroom mycelium colonizes the casing is called case hold, case run, or set-back. After the casing layer is colonized, the growing environment is usually manipulated to help stimulate the development of mushroom primordia which then become harvestable mushrooms.

The spacing and size distribution of mushroom primordia is a commercially significant factor called “pinset”. The pinset determines the number, size, and quality of the mushroom harvest. Primordia spaced too far apart will produce a sparse crop of large mushrooms. Primordia spaced too close together and developing all at once will produce a crop where the mushrooms are small in size, low in quality, and expensive to harvest. The ideal pinset contains moderate numbers of primordia well spaced in of various maturities. This is termed a “staggered” pinset. With a staggered pinset, the crop can be picked over several days. This produces the best yields and quality leading to maximum return for the mushroom cultivators.

Mushroom cultivation requires the production of edible mushrooms with the exclusion of other fungi and bacteria. This task is often difficult since the mushroom-growing environment is far from sterile. Many microbial competitors and pathogenic organisms exist and can often cause crop losses. Losses due to microbial competitors and pathogens can range in impact from mild annoyances to devastating crop losses.

Accordingly, the mushroom growing industry is in need of an improved formulation for a medium for growing fungi and the like which would promote rapid colonization thereby reducing the duration of spawn run, and a formulation which would provide more rapid growth of the casing layer and a more staggered pinset.

### SUMMARY OF THE INVENTION

In accordance with the present invention, compositions and methods for growing fungi, mushrooms and the like are presented. The present invention provides for an improved medium for the growth of fungi including mushrooms, and similar organisms, the medium including an effective amount of oat hulls. The present invention further provides a growing medium that promotes rapid colonization of the mushroom crop by shortening spawn run duration by at least 15-30%. Further, the growing medium of the present invention containing oat hulls inhibits the occurrence of certain mushroom diseases and mushroom competitors. Further, the present invention provides a casing spawn formed from a growing medium including an effective amount of oat hulls, the growing medium of the present invention provides a more rapid and vigorous growth in the casing layer and a more staggered pinset.

The present invention provides for growing mediums used in both substrate spawn and casing spawn formulations that contain effective quantities of oat hulls. Oat hulls are the seed hulls of the commonly cultivated grass plant Avena sativa. The hulls are the waste product discarded during the production of oat meal, rolled oats, etc. Oat hulls have surprisingly been found to have a remarkable and previously unsuspected ability to nurture, harbor, carry and transport fungal mycelium when compounded in appropriate amounts. Other grass seed hulls having a similar structure and mycelium carrying properties to oat hulls also would be suitable.

### DETAILED DESCRIPTION OF THE PREFERRED EMBODIMENTS

It is to be understood that the descriptions of the present invention have been simplified to illustrate elements that are relevant for a clear understanding of the invention, while eliminating, for purposes of clarity, other elements that may be well known. Those of ordinary skill in the art will recognize that other materials may be desired to implement the different embodiments of present invention. The detailed description will be provided herein below.

In one embodiment of the present invention, mushrooms are cultivated using a medium for growing mushrooms comprised of an effective amount of oat hulls. An example of a method of making mushrooms according to the present invention includes the following steps. A growing medium containing an effective amount of oat hulls is prepared. The growing medium of the present invention comprises oat hulls, preferably in the range of about 1-55% of the total weight of the growing medium, more preferably of about 10-25% and most preferably of about 15-20%; optionally, a calcium salt such as calcium carbonate and/or calcium sulfate in the range of about 0-10% of the total weight, preferably of about 4-6%; optionally, nitrogenous nutrients such as wheat bran, oat bran, rice bran or soy powder in the range of about 0-30% of the total weight, preferably of about 10-20%; optionally, non-nutritive particulate material such as vermiculite, peat moss or coir fiber in the range of about 0-30% of the total weight, preferably of about 10-20%; and moisture or water in the range of about 30-70% of the total weight, preferably of about 40-60%, and most preferably of about 50%.

In one embodiment, a formulation (referred to as “XCI” in the following examples) of the present invention may be: 15% oat hulls of the total weight; 15% vermiculite of the total weight; 15% wheat bran of the total weight; 3% calcium carbonate (chalk) of the total weight; 2% calcium sulfate (gypsum) of the total weight; and 50% water of the total weight.

The growing medium of the present invention is inoculated with mushroom mycelium by adding and mixing an effective amount of mushroom mycelium cells to form a substrate spawn. The mushroom mycelium then grows out from the substrate spawn and colonizes the nutritive matrix during spawn run.

After spawn run, a non-nutritive layer called a casing layer may be added on top of the nutritive matrix in order to stimulate the production of mushrooms. In order to minimize the duration of case hold, specific casing spawn products comprising a growing medium containing an effective amount of oat hulls may also be added to the casing layer. After the casing layer is colonized the growing environment may be manipulated to help stimulate mushroom production. The casing layer spawn formulation may be the same or different from the substrate spawn formulation.

In another embodiment, a nutritive mix as described above is colonized with mushroom mycelium. Then the resulting colonized block is used as the nutritive substrate for direct production of mushrooms.

### EXAMPLE 1

In three experiments conducted at a Quincy, Fla. mushroom farm owned by the assignee of record, a formulation of the present invention (XCI: 15% oat hulls of the total weight; 15% vermiculite of the total weight; 15% wheat bran of the total weight; 3% calcium carbonate (chalk) of the total weight; 2% calcium sulfate (gypsum) of the total weight; and 50% water of the total weight), was compared against two controls CAC (spawn run and chopped compost) at 14 pounds per tray, and CI-2 (casing spawn formula containing no oat hulls commercially available from the assignee of record). The purpose of the trials was to assess the performance of the formulation relative to the most common alternatives when used as casing spawn. Each experiment consisted of three treatments applied at casing as follows: XCI at 2 pounds per tray, CAC at 14 pounds per tray, and CI-2 at two pounds per tray. Six trays were prepared from each treatment in crops 126, 189, and 196. Each trial was monitored.

Results were as follows: On day eight after casing, the CAC trays and the XCI trays exhibited strong mycelia with prominent thick rhizomorphic growth. The trays with the CI-2 formula were grown through but with thinner, more uniform mycelium. On day 13 after casing, the XCI had an abundance of thumb-sized well-spaced primordia. The CAC trays also had large primordia. The CI-2 trays had fewer smaller mushroom primordia. On day sixteen, the XCI trays and the CAC trays were ready to harvest, with a full crop of large mushrooms. The CI-2 trays were one or two days behind, and not as full.

In these experiments the XCI was more aggressive in promoting rapid, high yield, cropping than the CI-2. Also, the XCI produced a crop of the same value and timing as the CAC even though a much smaller amount was used.

Grower comments were that the XCI was the strongest and best casing spawn they had used. Further, the grower watching this experiment noticed that the second and third breaks with the XCI exceeded the CAC in yield.

### EXAMPLE 2

Two trials were undertaken at a mushroom trial farm owned by the assignee of record located in Kittanning, Pa. where a formulation (XCI) was used in place of conventional grain spawn, i.e., added to the compost layer of the mushroom trays. This experiment was repeated twice, once in crop M38 and again in crop M46. In each case the XCI was used at a rate of 300 grams per tray to spawn three mushroom trays. The controls were CI-2 (casing spawn formula containing no oat hulls commercially available from the assignee of record.) and conventional grain spawn. Both controls employed a spawn rate of 300 grams per tray in three trays each.

In both of these tests the commercial CI-2 colonization of the compost was slow and weak, leading to a delayed crop. The grain spawn colonized the compost in the usual 13 days. The XCI, however, induced very rapid compost colonization and was ready to case in ten days.

### EXAMPLE 3

Three trials were carried out at yet another farm to test the value of the formulation (XCI) when used in the casing. In each trial, six trays were prepared with XCI and placed in a growing room where the balance of the trays were prepared using the farm's standard treatment, CI-2 (casing spawn formula containing no oat hulls commercially available from the assignee of record.).

In all three trials, the growers were able to observe that the mushroom crop was produced with superior “stagger” where XCI was used. That is, the sizing and spacing of the mushrooms on the XCI trays were more conducive to picking the crop over more days and getting better yields and higher quality mushrooms.

The growers concluded that a crop grown on XCI would be of greater value and require less labor expense to produce than a conventional CI-2 crop.

Although the invention has been described in terms of particular embodiments in an application, one of ordinary skill in the art, in light of the teachings herein, can generate additional embodiments and modifications without departing from the spirit of, or exceeding the scope of, the claimed invention. Accordingly, it is understood that the descriptions herein are proffered only to facilitate comprehension of the invention and should not be construed to limit the scope thereof.

What is claimed is:

1. A growing medium to improve the growth of mushrooms or other fungi comprising:
an effective amount of oat hulls.

2. The growing medium of claim 1, wherein the oat hulls are in the range of 1-55% of the total weight of the growing medium.

3. The growing medium of claim 2, wherein the oat hulls are in the range of 15-20% of the total weight of the growing medium.

4. The growing medium of claim 1, further comprising a non-nutritive particulate material.

5. The growing medium of claim 4 wherein, the non-nutritive particulate material comprises at least one non-nutritive particulate material selected from the group consisting of vermiculite, peat moss, and coir fiber.

6. The growing medium of claim 1, further comprising a nitrogenous nutrient.

7. The growing medium of claim 6, wherein the nitrogenous nutrient comprises at least one nitrogenous nutrient selected from the group consisting of wheat bran, oat bran, rice bran and soy powder.

8. The growing medium of claim 1, further comprising a calcium salt.

9. The growing medium of claim 8, wherein the calcium salt comprises at least one calcium salt selected from the group consisting of calcium carbonate and calcium sulfate.

10. The growing medium of claim 1, further comprising water.

11. The growing medium of claim 1, further comprising a non-nutritive particulate material; a nitrogenous nutrient; a calcium salt; and water.

12. A method of growing mushrooms or other fungi, comprising the steps of:
providing a nutritive layer;
providing a growing medium comprising an effective amount of oat hulls; and
inoculating the growing medium with mushroom mycelium to form a substrate spawn;
adding the substrate spawn to the nutritive layer; and
incubating the composition to produce mushrooms.

13. The method of claim 12, further comprising the step of adding a casing layer including a casing spawn formed from a growing medium comprising an effective amount of oat hulls.

14. A growing medium that promotes rapid colonization of a mushroom crop by shortening spawn run duration by at least 15%.

15. The method of claim 12, further comprising the use of the invention as the primary nutritive medium for the production of mushrooms.
